(19) United States
(12) Patent Application Publication
(10) Pub. No.: US 2017/0109332 A1
(43) Pub. Date: Apr. 20, 2017

(54) MATCHING USER INPUT PROVIDED TO AN INPUT METHOD EDITOR WITH TEXT

(71) Applicant: SuccessFactors, Inc., South San Francisco, CA (US)

(72) Inventors: He Kun WANG, Shanghai (CN); Xiaoyi WANG, Shanghai (CN)

(21) Appl. No.: 14/884,834

(22) Filed: Oct. 16, 2015

(51) Int. Cl. G06F 17/24; G06F 17/27; G06F 17/28; G06F 17/22

(52) U.S. Cl. CPC G06F 17/24; G06F 17/2223; G06F 17/276; G06F 17/2827; G06F 17/2282

(57) ABSTRACT

A framework for improving the speed of text entry is described herein, particularly text from languages that contain characters that are pronounced similarly but have different written forms. One embodiment of the invention disambiguates the desired written form of a pronunciation based on information retrieved from an address book, social networking profile, and the like.

### BACKGROUND

While entering text into a computing device, it is common to refer to a contact, such as a person, a business, etc. For example, messages commonly refer to a person or business's name, nickname, or address. However, when the text is entered using an input method editor, multiple inputs, e.g., keystrokes, may be required to generate the desired text representation. For example, the pinyin input method for entering Chinese characters receives text representing a pronunciation of a character or characters. The pronunciation is looked-up in a dictionary, and one or more corresponding characters that share the pronunciation are retrieved and presented to a user to choose from. This process may be repeated multiple times, and is often considered time consuming and tedious. The situation is worse when a person's name is long, or if the person's name is not found in the dictionary.

Therefore, there is a need for an improved framework that addresses the above-mentioned challenges.

### SUMMARY

A framework for improving the speed of text entry is described herein. Text is often entered into a computing device on a keyboard that does not contain a key for each character in a given character set. For example, many keyboards do not depict even a small fraction of Chinese, Japanese, or Korean characters. One input method technique used to enter these characters, such as pinyin, is to type the pronunciation of the character on a Latin (e.g., QWERTY) keyboard. However, many languages include a plurality of characters that are distinct in written form, but that are pronounced the same. Thus, input method techniques such as pinyin list characters matching the pronunciation for the user to choose from.

However, it is possible to disambiguate which character is desired in cases where more information about the character being entered can be retrieved. In one embodiment, a user may wish to type a person's name. The user may have an address book that includes both the pronunciation and the written characters constituting the person's name. In one embodiment, the input method technique looks-up the name in the address book based on the pronunciation entered by the user, and suggests or even automatically inserts the corresponding character(s) into the text.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 illustrates an overview of one embodiment of translating text from a first character set to a second character set;

FIG. 3 illustrates one embodiment of translating text from a first character set to a second character set; and

FIG. 4 is a flow chart illustrating one embodiment of translating text from a first character set to a second character set.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

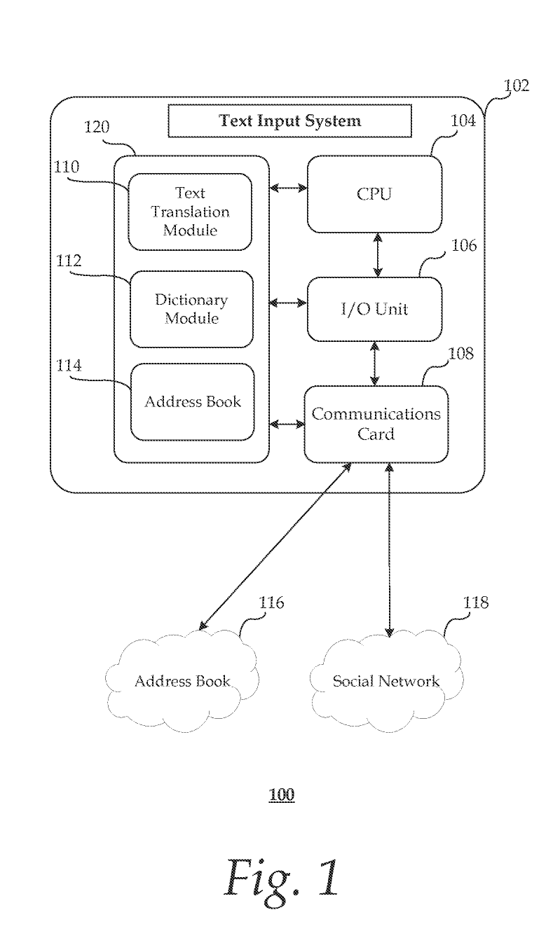

FIG. 1 is a block diagram illustrating an exemplary architecture 100 that may be used to implement the framework described herein. Generally, architecture 100 may include a text input system 102, a cloud-based address book 116 and social network 118.

Text input system 102 can be any type of computing device capable of receiving user input, such as a workstation, a server, a portable laptop computer, another portable device, a mini-computer, a mainframe computer, a storage system, a dedicated digital appliance, a device, a component, other equipment, or some combination of these. Text input system 102 may include a central processing unit (CPU) 104, an input/output (I/O) unit 106, a memory module 120 and a communications card or device 108 (e.g., modem and/or network adapter) for exchanging data with a network (e.g., local area network (LAN) or a wide area network (WAN)). It should be appreciated that the different components and sub-components of the Text input system 102 may be located on different machines or systems.

Text input system 102 may be communicatively coupled to one or more other computer systems or devices via the network. For instance, Text input system 102 may further be communicatively coupled to one or more social network 118. Social network 118 may be, for example, any app or web site containing contact profile data, e.g., a profile owner's name, nickname, address, etc. Examples of social networks include Facebook®, LinkedIn®, Twitter®, Myspace®, Google+®, Match.com® and the like.

Text input system 102 may also be communicatively coupled to address book 116. Address book 116 may store contact information including name, nickname, address, and the like. Examples of address book 116 include Outlook®, Gmail®, Yahoo!® mail, and the like.

Text Translation Module 110 includes logic for receiving text in a first character set and translating it to a second character set. In one embodiment, the first character set is a Latin character set, such as the English alphabet, while the second character set is a set of characters that do not map one-to-one to keys on traditional keyboards (e.g., QWERTY, DVORAK, etc.). However, while the character sets may differ, the language of input text and the output text is often the same. For example, the input text may use the pinyin representation of Chinese characters, while the second character set may be Chinese characters themselves. Pinyin and Chinese characters are but one example—any alternative input method, for any language, is similarly considered. For example, gestures received on a touch-screen device may define the first character set, while English characters define the second character set.

In one embodiment, an input text is received in the first character set, and is translated to the second character set based on information extracted from address book 114, cloud-based address book 116, social network 118, or the like. In one embodiment the input text represents a pronunciation of a word, while the information extracted from address book 114, cloud-based address book 116, social network 118, etc., represents the spelling of the word.

Dictionary module 112 includes logic for, given the input text in the first character set, looking up the output text in the second character set. Typically, these dictionaries are statically embedded in Input Method Editors (IMEs). As such, even if the IME dictionary recognizes the pronunciation represented in the input text, it is unaware of any additional context, such as a friendship relationship between the person entering text and a contact whose name is being entered. As such, these existing dictionaries are unable to resolve some ambiguities when converting from a pronunciation (text input) to a written form (text output).

Address book 114 (in addition to cloud-based address book 116 and social network 118) includes a list of contact information usable by text translation module 110 to disambiguate characters associated with the same pronunciation as the input text. For example, address book 114 may include contact information of persons or businesses, including names, nicknames, email addresses, web addresses, mailing addresses, and the like. This contact information may be stored in the first character set, e.g., in a pinyin representation, and the second character set, e.g., Chinese characters, thereby establishing a mapping usable to identify the relevant output text. However, associating the input text and the output text by a shared pronunciation is one embodiment—other types of associations, such as characters or words that have the same spelling but different pronunciations, are similarly contemplated.

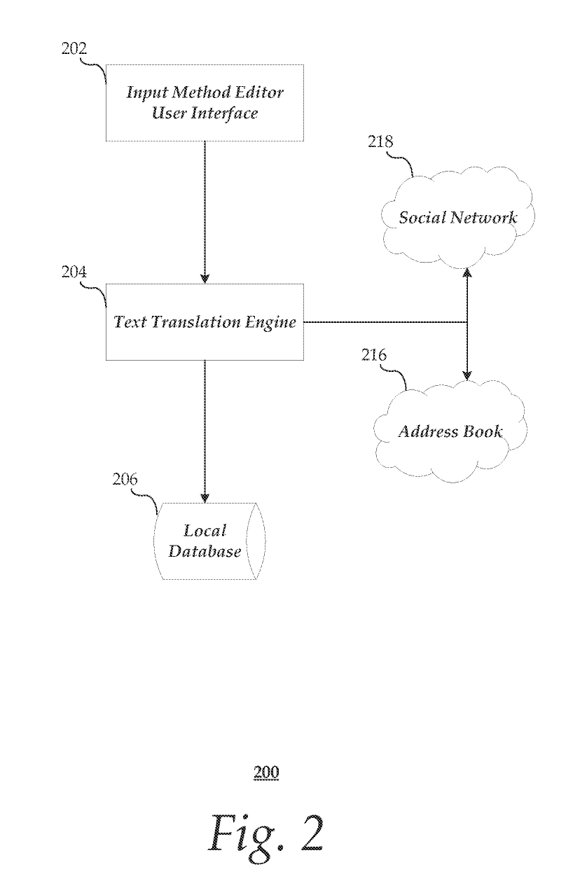

FIG. 2 illustrates an overview 200 of one embodiment of translating text from a first character set to a second character set. Input method editor (IME) user interface (UI) 202, text translation engine 204, and local database 206 may be performed automatically or semi-automatically by the Text input system 102, described above with reference to FIG. 1.

In one embodiment, IME user interface UI) 202 receives user input text in the first character set. In the example of the pinyin input method, users are enabled to enter characters from the English alphabet, or alphabets from other Latin languages. Other character sets, including Cyrillic, Greek, Arabic, Devanagari, and the like, are similarly contemplated. In one embodiment, the user input text is received from a keyboard (physical or virtual), although characters could be input in any way—gestures, speech to text translation, etc. In one embodiment, the user input text represents a pronunciation of a character.

In one embodiment, IME UI 202 provides the user input text to text translation engine 204. Text translation engine 204 attempts to convert the user input text into the second character set. In the pinyin example, the second character set includes Chinese characters. However, in many languages, Chinese being but one example, multiple characters may share a same pronunciation, and so there is not always a one-to-one mapping of pronunciations to characters. In these cases, text translation engine 204 consults local database 206 for a list of characters matching the received pronunciation, and then returns the list of characters to IME UI 202 for the user to select a particular character.

In one embodiment, when local database 206 does not contain any characters matching a pronunciation, or when text translation engine 204 in concert with local database 206 determines that the input text represents contact information (e.g., name, nickname, address), text translation engine consults one or more address books 216 or social networks 218 to determine and/or disambiguate the text output in the second character set.

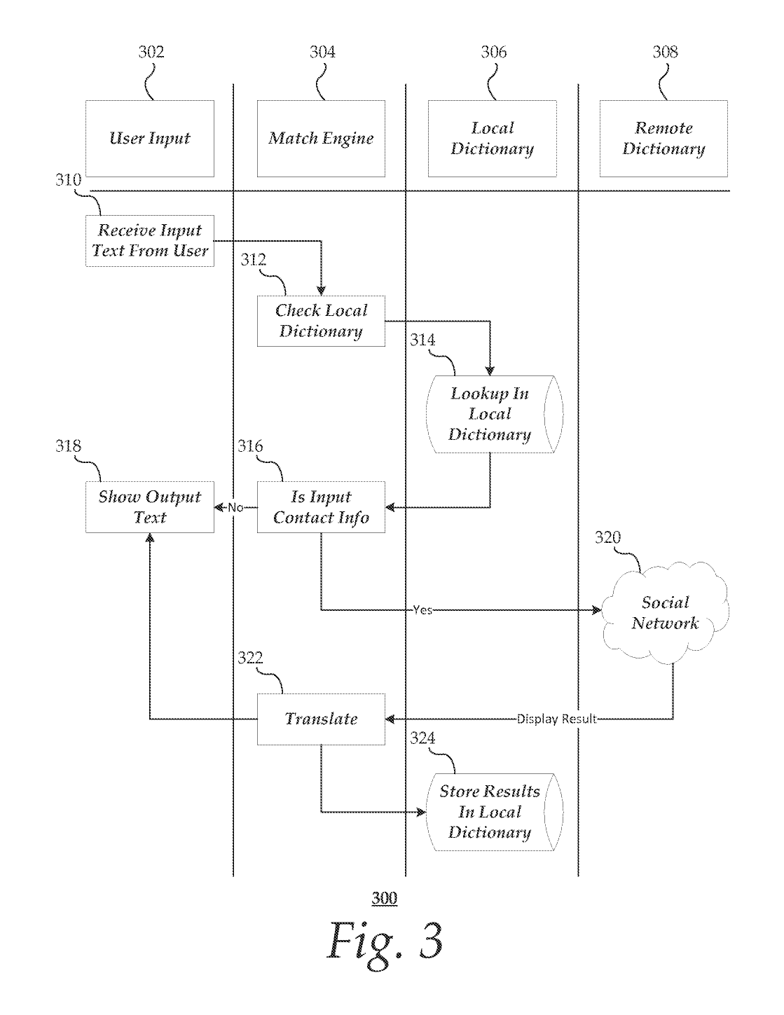

FIG. 3 illustrates one embodiment 300 of translating text from a first character set to a second character set, partitioned by which module is performing a given action. For example, the user may have a colleague with the English name John, but the user would like to enter John's Chinese name, [symbol] .

User input 302 receives 310 input text from a user. The input may be received from key presses on keyboard, physical or virtual, touches perceived by a touch screen, gestures from a touch screen or inferred from mouse/track ball movement, sign language performed in front of a motion sensing input device, voice recognition, etc. In one embodiment the input text represents a pronunciation of a character or characters. Continuing the example, the pinyin representation of “John” is “yuehan”, and so at step 310 the user would type “yuehan” into user input 302.

The input text is then provided to match engine 304 for processing. Match engine 304 may be implemented by text translation module 110, as discussed above with reference to FIG. 1. Match engine 304 may first check local dictionary 312, by performing a lookup 314 in local dictionary 306 for any information associated with the input text. If local dictionary 306 can match the input text to one or more characters having the same pronunciation, this list of characters will be returned. Additionally or alternatively, local dictionary may identify the text input as a name, nickname, mailing address, email address, nickname, Twitter® handle, or other type of contact information. The information associated with the input text is then returned to match engine 304.

Match engine 304 then determines 316, based on the information returned from local dictionary 306, whether the input text is contact information. Continuing the example, local dictionary 306 may have indicated that “yuehan” is a name. Additionally or alternatively, match engine 304 may use other means to identify the input text as another type of contact information, such as a mailing address parser, nickname dictionary, and the like.

When match engine 304 determines the input text is not contact info, the one or more characters having the same pronunciation are returned to user input 302 to be shown 318. If there are multiple characters having the same pronunciation, the end user is enabled to select the desired character as the output text.

However, when match engine 304 determines that the input text does contain contact information, it consults at step 320 one or more remote dictionaries 308, e.g., address books and/or social networks, to attempt to determine the appropriate character or characters of desired output text. In one embodiment, match engine 304 may download social network profile information associated with the input text. Continuing the example, John may have a Facebook® profile with the English name John and the Chinese name “ [symbol] ”. In this case, match engine 304 may know, based on a table look-up, that “yuehan” is the pinyin representation of John, and thereby retrieve John's profile. Additionally or alternatively, John's profile may include the pinyin representation of John's English name, “yuehan”, in which case the profile is retrieved directly based on the input text. In either case, once the profile, or information derived therefrom, is received, match engine 304 retrieves John's Chinese name “ [symbol] ”. Retrieving this information from a social network is but one example. Similar retrievals from address books, such as address book 114 and cloud-based address book 116, are also contemplated.

Once the social network profile information has been received, match engine 304 translates at step 322 the input text into the output text. In one embodiment the input text is translated by direct association, e.g., the name “yuehan” is spelled “ [symbol] ” on the user's friend's John's Facebook® page, and so the output text is determined to be “ [symbol] ”.

In another embodiment, the translation is indirect. The user may have multiple friends named John, all of which spell their name the same way. As such, match engine 304 may choose the Chinese name “ [symbol] ” despite not knowing which John is intended. In another embodiment, when the input text represents an email address, nickname, mailing address, or the like, the corresponding piece of information is retrieved from the social networking profile and used to translate into the second character set.

Once translation 322 has taken place, the output text is returned to the user input 302 for display, transmission, or the like. Also, in one embodiment, the determined translation is stored in the local dictionary 324 to speed future translations by avoiding requests to social networking profiles, address books, and the like.

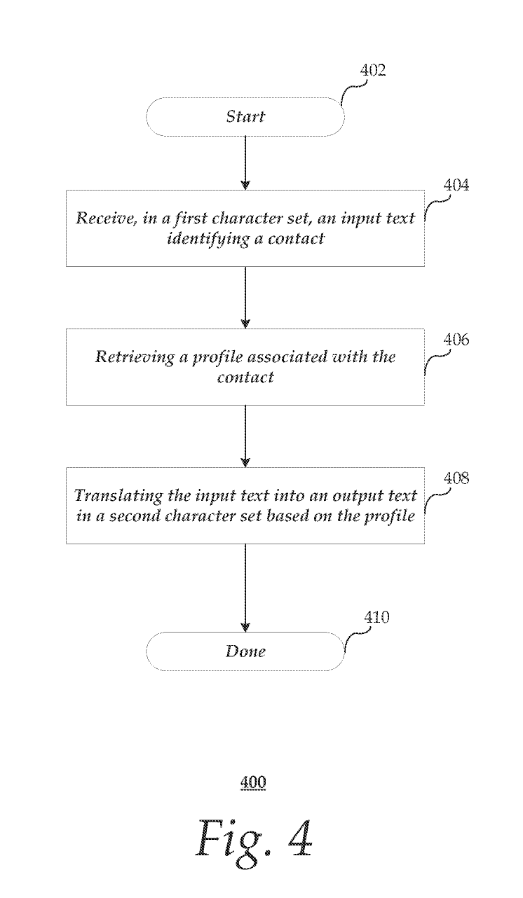

FIG. 4 is a flow chart 400 illustrating one embodiment of translating text from a first character set to a second character set. In one embodiment, routine 400 may be implemented by match engine 304 of Text input system 102. The routine begins at start block 402.

In block 404, routine 400 receives, in a first character set, an input text identifying a contact. In one embodiment the contact is a name, nickname, address, email address, web address, or the like. In one embodiment the character set is a Latin character set, such as English, but the input text represents a pronunciation of one or more characters from a second character set, e.g., Chinese characters. In one embodiment, the second character set has characters or words that are pronounced similarly or the same, while typographically are different.

In block 406, routine 400 retrieves an address book entry or social networking profile associated with the contact, or data derived therefrom. In one embodiment the address book entry or social networking profile is indexed based on the pronunciation of the contact. For example, if the user input is “yuehan”, the address book entry or social networking profile is retrieved based on the name “yuehan”. In another embodiment, the input text is translated to another language, and the address book entry and/or social networking profile is retrieved based on the translation. For example, the name “yuehan” may be translated to “John” before performing the look-up. In one embodiment, look-ups into social networks are limited to friendship or other acquaintance relationships. There may be many people named “John” on Facebook®, but perhaps only one who is a friend of the user. In this way, different Chinese spellings of “John” are disambiguated by limiting the look-up to the user's friends.

In block 408, routine 400 translates the input text into an output text in the second character set based on the retrieved address book entry and/or social networking profile. In one embodiment, the output text in the second character set is retrieved directly from the address book entry and/or social networking profile.

In done block 410, routine 400 ends.

What is claimed is:

1. A computer-implemented method of entering text, comprising:
receiving, in a first character set, an input text identifying a contact;
retrieving a profile associated with the contact; and
translating, with the computer, the input text in the first character set into an output text in a second character set based the profile.

2. The computer-implemented method of claim 1, wherein
the second character set includes a plurality of different characters having a same pronunciation; and
the input text represents the same pronunciation.

3. The computer-implemented method of claim 1, wherein the profile is retrieved based on the input text.

4. The computer-implemented method of claim 3, wherein the translating extracts one of the plurality of different characters from the profile.

5. The computer-implemented method of claim 2, wherein the input text comprises an abbreviation of a name, wherein the name has the same pronunciation.

6. The computer-implemented method of claim 1, wherein
the first character set is associated with a first language; and
the second character set is associated with a second language.

7. The computer-implemented method of claim 1, wherein the profile is dynamically retrieved in response to receiving the input text.

8. The computer-implemented method of claim 2, wherein
the first character set is an English alphabet;
the second character set is a set of Chinese characters; and
the translation of the input text to the output text utilizes a pinyin input method.

9. A non-transitory computer-readable storage medium for entering text, the computer-readable storage medium including instructions that when executed by a computer, cause the computer to:
receive, in a first character set, an input text identifying a contact;
retrieve a profile associated with the contact; and
translate the input text in the first character set into an output text in a second character set based on the profile.

10. The non-transitory computer-readable storage medium of claim 9, wherein
the second character set includes a plurality of different characters having a same pronunciation; and
the input text represents the same pronunciation.

11. The non-transitory computer-readable storage medium of claim 9, wherein the profile comprises an address book entry or a social networking profile.

12. The non-transitory computer-readable storage medium of claim 9, wherein the input text is received from one or more key strokes.

13. The non-transitory computer-readable storage medium of claim 9, wherein the input text comprises a name of the contact, a nickname of the contact, or a postal address associated with the contact.

14. The non-transitory computer-readable storage medium of claim 9, wherein the contact comprises a person, a business, a government entity, or a non-profit organization.

15. A computing apparatus for entering text, the computing apparatus comprising:
a processor; and
a memory storing instructions that, when executed by the processor, configure the apparatus to
receive, in a first character set, an input text, and
look-up the input text in a dictionary that translates text in the first character set into text in a second character set wherein
if the dictionary indicates that the input text identifies a contact, the apparatus
retrieves a profile associated with the contact, and
translates the input text in the first character set into an output text in the second character set based the profile; and
if the dictionary indicates that the input text does not identify a contact, the apparatus produces as the output text a translation given by the dictionary.

16. The computing apparatus of claim 15, wherein the second character set includes a plurality of different characters having a same pronunciation, and wherein the input text represents the same pronunciation.

17. The computing apparatus of claim 15, wherein the input text and the output text represent the same word in the same language.

18. The computing apparatus of claim 15, wherein the profile is retrieved based on the input text.

19. The computing apparatus of claim 15, wherein the profile comprises data associated with the profile.

20. The computing apparatus of claim 15, wherein the memory stores further instructions, that when executed by the processor, further configures the apparatus to store the association of the input text and the output text in the dictionary.
